(19) United States
(12) Patent Application Publication
(10) Pub. No.: US 2026/0043947 A1
(43) Pub. Date: Feb. 12, 2026

(54) OPTICAL DEVICES THAT INCLUDE A PROTECTED LENS

(71) Applicant: NIL Technology ApS, Kongens Lyngby (DK)

(72) Inventors: Fredrik Mattinson, Stockholm (SE); Stefano Atella, Zurich (CH); Ehsan Hashemi, Stockholm (SE); Olivier Francois, Copenhagen (DK); Ulrich Quaade, Copenhagen (DK)

(21) Appl. No.: 19/102,755

(22) PCT Filed: Aug. 10, 2023
(86) PCT No.: PCT/EP2023/072237

§ 371 Date: Feb. 10, 2025

Related U.S. Application Data
(60) Provisional application No. 63/371,166, filed on Aug. 11, 2022.

(51) Int. Cl. G02B 1/14; G02B 3/02; G02B 5/00; G02B 7/02

(52) U.S. Cl. CPC G02B 1/14; G02B 3/02; G02B 5/005; G02B 7/02

(57) ABSTRACT

The present disclosure describes, among other things, optical devices in which a lens structure is closer to an aperture substrate than is a support on which the lens structure is disposed. The lens structure is defined throughout a metasurface that is distributed across a surface of a support of a lens substrate and that comprises metaatoms configured to change a local amplitude, a local phase, or both, of a light wave at an application wavelength. The present disclosure also describes assemblies incorporating one or more such optical devices, as well as methods of manufacturing the optical devices.

### FIELD OF THE DISCLOSURE

The present disclosure relates to optical devices that include a protected lens.

### BACKGROUND

Wafer-level stacking sometimes is used to align optical apertures to lenses during fabrication of optical devices. In some instances, subsequent handling of the optical devices may result in the lenses becoming scratched or otherwise damaged.

### SUMMARY

The present disclosure describes optical devices in which a lens structure that is distributed across a surface of a glass or other support faces the optical substrate that has an optical structure. The present disclosure also describes assemblies incorporating one or more such optical devices, as well as methods of manufacturing the optical devices and assemblies.

For example, in one aspect, the present disclosure describes an apparatus that includes an aperture substrate, a lens substrate and a spacer. The aperture substrate has an optical aperture. The lens substrate includes a lens structure on a support, the lens structure being closer to the aperture substrate than is the support. The lens structure is defined throughout a metasurface distributed across a surface of the support and comprises meta-atoms configured to change a local amplitude, a local phase, or both, of a light wave at an application wavelength. The support is transparent to the application wavelength. A first end of the spacer is attached to the aperture substrate, and a second end of the spacer is attached either to the lens substrate or to a protective covering that covers the metasurface. An opening extends through the spacer from the first end to the second end, wherein the opening has an index of refraction equal to or less than 1.0.

Some implementations include one or more of the following features. For example, in some implementations, the aperture substrate includes a first support on which a metal layer is disposed, wherein the metal layer defines the optical aperture, and the first support is transparent to the application wavelength. In some implementations, the lens structure faces the optical aperture, whereas in some implementations, the lens structure faces the first support. In some cases, the support on which the lens structure is disposed and the first support on which the metal layer is disposed are composed of glass. In some implementations, the metal layer defining the optical aperture is composed of a black chrome coating. In some implementations, the opening in the spacer contains air.

In some implementations, the apparatus further includes an image sensor disposed so that light entering through the optical aperture passes through the lens structure and then is incident on the image sensor.

The present disclosure also describes methods of manufacturing optical devices. For example, in one aspect, a method includes providing a first wafer on which a metal layer is disposed, wherein the metal layer defines optical apertures, and the first wafer is transparent to an application wavelength. The method includes providing a second wafer having a lens structure on a surface of the second wafer, wherein the lens structure is defined by a metastructure distributed across a surface of the second wafer and comprises meta-atoms configured to change a local amplitude, a local phase, or both, of a light wave at the application wavelength, and wherein the second wafer is transparent to the application wavelength. The method further includes providing a spacer wafer, wherein there are openings extending through the spacer wafer from a first side of the spacer wafer to a second side of the spacer, and wherein the openings have an index of refraction equal to or less than 1.0. The first side of the spacer wafer is attached to the first wafer, and the second side of the spacer wafer is attached either to the second wafer, or to a protective covering that covers the metastructure, to form a wafer stack, such that the lens structure is closer to the first wafer than is the second wafer, and wherein each of the optical apertures is aligned with a respective one of the openings in the spacer wafer.

Some implementations include one or more of the following features. For example, in some implementations, the method includes separating the wafer stack into individual optical devices. In some implementations, the method includes
providing an image sensor so that light entering through the optical aperture of one of the individual optical devices passes through the lens structure and then is incident on the image sensor.

Some implementations can provide one or more of the following advantages. For example, by placing the lens structure on the side of the lens substrate that faces the aperture substrate, the likelihood that the lens structure will become scratched or otherwise damaged during subsequent handling of the optical device can be reduced. The presence of an air or other low-index optically clear material core region (e.g., rather than glass) between the active region of the lens structure and the aperture can result, in some cases, in the optical device having a relatively small total z-height and/or small total track length (TTL). Also, in some implementations, using a relatively thin glass substrate to support the lens structure can help keep the influence of optical aberrations caused by converging light beams through the flat surface of the glass substrate relatively small.

Other aspects, features and advantages will be readily apparent form the following detailed description, the accompanying drawings, and the claims.

### BRIEF DESCRIPTION OF THE DRAWINGS

FIG. 1 illustrates an example of an optical device.

FIGS. 2 and 3 illustrate stages in the wafer-level fabrication of optical devices as in FIG. 1.

FIG. 4 illustrates an example of an optical assembly that includes the optical device of FIG. 1.

FIG. 5 illustrates an example of light beams being sensed by the optical assembly of FIG. 4.

FIG. 6 illustrates another example of an optical device.

FIG. 7 illustrates a further example of an optical device.

FIG. 8 illustrates yet another example of an optical device.

### DETAILED DESCRIPTION

The present disclosure describes optical devices in which an active region of the lens structure faces the aperture substrate and thereby can be protected within an interior area of the device. Some of the example implementations described below refer to meta-optical elements (MOEs) as an example of the lens structure. However, the devices and techniques described in the present disclosure also can be used with other types of lenses (e.g., diffractive optical elements (DOEs)) that are distributed across the surface of a glass or other transparent support.

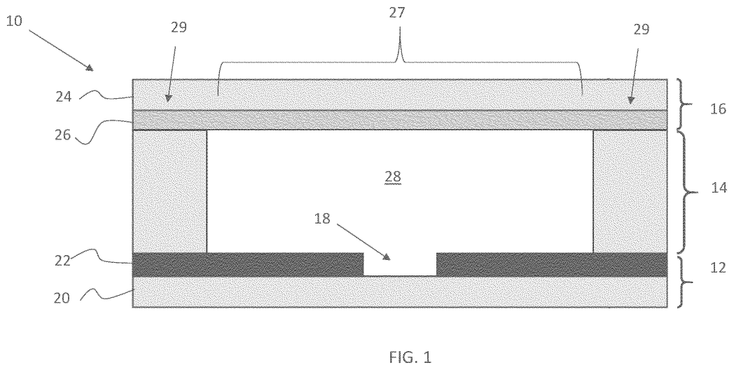

As shown in the example of FIG. 1, an optical device 10 includes an aperture substrate 12, a spacer 14 attached to the aperture substrate 12, and a lens substrate 16 attached to the spacer 14. The substrates 12, 16 and wafer 14 are stacked one on the other, with the spacer 14 disposed between the aperture substrate 12 and the lens substrate 16.

The aperture substrate 12 includes an aperture 18 defined, for example, by a metal layer (e.g., black chrome coating) 22 on the surface of a first support 20. The support 20 is transparent to the intended application wavelength, or range of wavelengths (e.g., near infra-red (IR), IR, or visible), for the device 10. For example, in some implementations, the application wavelength may be 940 nm, 1380 nm, or 1550 nm. The support 20 can be composed, for example, of glass or other transparent material. In some implementations, the first support 20 is composed of D 263® T glass, which is a nearly colorless flat borosilicate thin glass made by SCHOTT. Other types of glass or transparent materials (e.g., SCHOTT MEMpax® ultra-thin borosilicate glass) may be used in some implementations.

The lens substrate 16 includes a lens structure 26 on a surface of a second support 24. The support 24 also is transparent to the intended application wavelength, or range of wavelengths for the device 10 and can be composed, for example, of glass. In some implementations, the support 24 is composed of D 263® T glass. Other types of glass or transparent materials may be used in some implementations.

In some implementations, the lens structure 26 is defined throughout a metasurface, which also may be referred to as metastructure. The metastructure can include small structures (e.g., nanostructures or other meta-atoms) distributed across the surface of the support 24 and arranged to interact with light in a particular manner. The nanostructures may, individually or collectively, interact with light waves. For example, the nanostructures or other meta-atoms may change a local amplitude, a local phase, or both, of an incoming light wave.

When meta-atoms (e.g., nanostructures) of a metasurface are in a particular arrangement, the metasurface may act as an optical element such as a lens, lens array, beam splitter, diffuser, polarizer, bandpass filter, or other optical element. In some instances, metasurfaces may perform optical functions that are traditionally performed by refractive and/or diffractive optical elements. The meta-atoms may be arranged, in some cases, in a pattern so that the metastructure functions, for example, as a lens, grating coupler or other optical element. In other instances, the meta-atoms need not be arranged in a pattern, and the metastructure can function, for example, as a fanout grating, diffuser or other optical element. In some implementations, the metasurfaces may perform other functions, including polarization control, negative refractive index transmission, beam deflection, vortex generation, polarization conversion, optical filtering, and plasmonic optical functions.

In the illustrated example of FIG. 1, the lens structure 26 includes an optically active region 27 surrounded laterally by an optically inactive region 29. One end of the spacer can be attached to the optically inactive region 29 of the lens substrate 16. The spacer 14, which separates the aperture 18 from the lens structure 26 by a specified distance, also can be composed, for example, of glass. Further, the spacer 14 can have an opening 28 that extends from one side of the spacer to the other side. In such an arrangement, the space within the opening 28 can have an index of refraction equal to or less than 1.0. For example, the opening 28 can contain a vacuum or can be filled with matter that is optically clear at the application wavelength (e.g., air). Such a configuration can allow the optical device, in some implementations, to have a relatively small total z-height and/or relatively small total track length (TTL). Implementations in which the opening 28 contains air or a vacuum can be preferable to filling the opening, for example, with an epoxy or polymer material, which may adversely impact optical performance due to the higher refractive index of such materials.

As shown in FIG. 1, the lens structure 26 is disposed on a surface of the second support 24 that faces the aperture substrate 12. That is, the lens structure faces the aperture 18, rather than being disposed on an exterior surface of the optical device 10. Such an arrangement allows the lens structure (e.g., the meta-atoms) 18 to be protected within an interior region 28 defined by the housing of the optical device 10 so that the likelihood of scratches or other damage to the lens structure 26 during subsequent handling of the optical device 10 can be reduced.

The arrangement of FIG. 1 can, in some instances, be less costly and/or less complicated to manufacture than situations in which the lens structure is disposed on the outer surface of the lens substrate and is encapsulated for protection. Although converging light beams through the flat surface of the glass support 24 might introduce optical aberrations, such aberrations depend, to a large extent, on the thickness of the support 24 and on its index of refraction. Thus, the influence of such aberrations can be kept relatively small by using a relatively thin support. For example, in some cases, the support 24 can have a thickness of about 200 μm. Other thicknesses may be appropriate for some implementations.

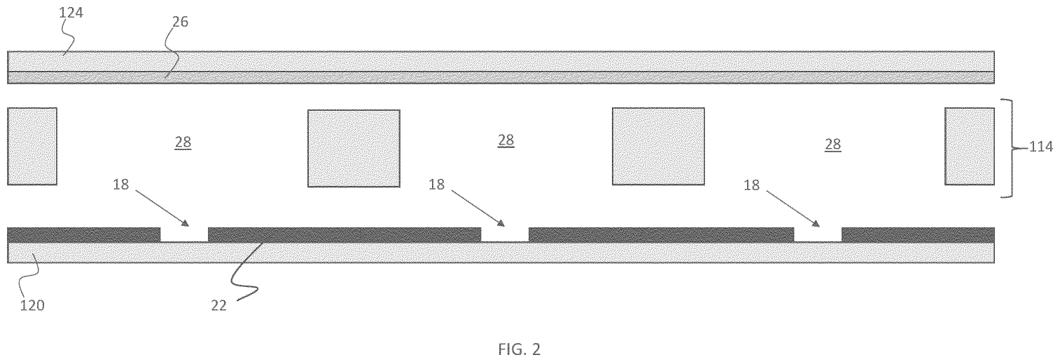

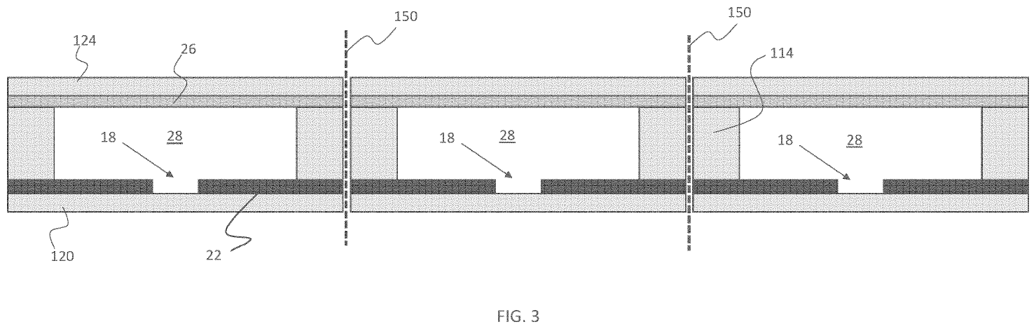

As noted above, the optical device 10 can be fabricated, for example, by a wafer-level process, an example of which is described in connection with FIGS. 2 and 3. As shown in FIG. 2, a first transparent (e.g., glass) wafer 120 is provided and has a thin metal layer 22 composed, for example, of a black chrome coating, on the surface of the wafer. The thin metal layer 22 defines optical apertures 18. A second transparent (e.g., glass) wafer 124 also is provided and has a lens structure 26 on its surface. The lens structure 26 can include, for example, a metastructure composed of nanostructures such as meta-atoms. In other implementations, the lens structure 26 may be composed of other types of lenses (e.g., DOEs) that are distributed across the surface of the second wafer 124. A spacer wafer 114, composed for example of glass, also is provided. The spacer wafer 114 includes openings 28, each of which extends through the spacer wafer from a first side to a second opposite side. The space defined by the openings 28 can have, for example, an index of refraction equal to or less than 1.0 and can be optically clear at the application wavelength. For example, the openings 28 may contain air or a vacuum.

Next, as shown in FIG. 3, the first wafer 120 is attached to the first side of the spacer wafer 114, and the second wafer 124 is attached to the second, opposite side of the spacer wafer 114 to form a wafer stack. The first and second wafers 120, 124 are attached to the spacer wafer 114 such that active regions of the lens structure 26 on the second wafer 124 face toward the first wafer 120 (or toward the thin metal layer 22 that defines the optical apertures 18). The wafers 120, 124 can be attached to the spacer wafer 114, for example, by an adhesive. Subsequently, the wafer structure can be separated into individual optical devices, for example, by dicing along dicing lines 150.

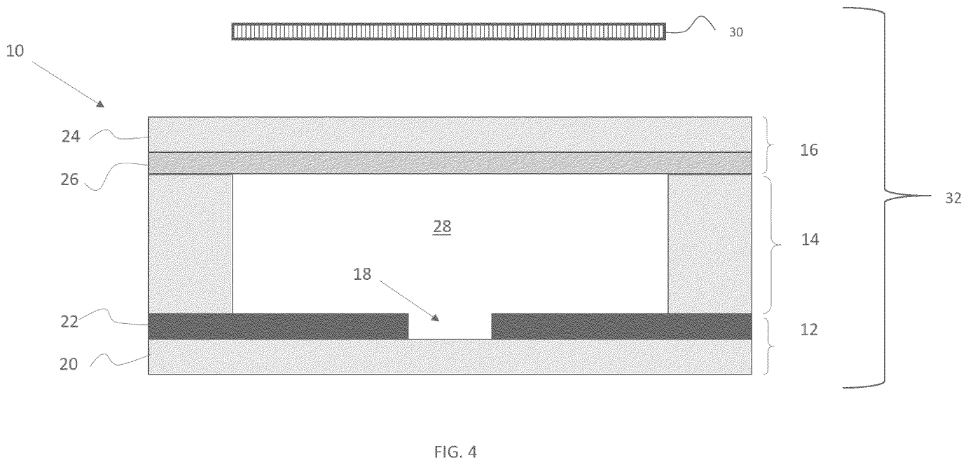

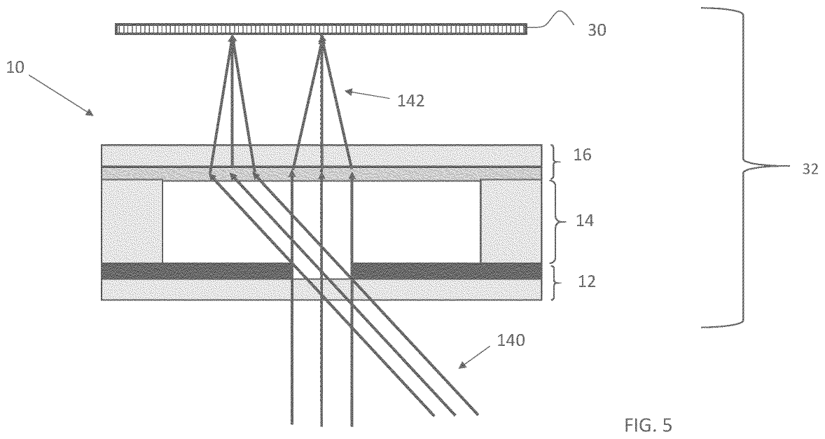

The optical device 10 can be integrated into an optoelectronic assembly, such as a light sensing module. As shown in the example of FIGS. 4 and 5, such an assembly 32 can include an image sensor 30 disposed so that light 140 entering the optical device 10 through the aperture 18 passes through the lens structure 26 before being incident on the image sensor 30. For example, if the lens structure 26 is implemented as a metasurface that includes meta-atoms, the meta-atoms may change a local amplitude, a local phase, or both, of incoming light waves 140. After passing through the lens structure 26, the modified light waves 142 are incident on the image sensor 30.

During assembly of the module, the optical device 10, which includes the lens structure 26, can be placed into a lens holder and actively aligned with the image sensor 30 before being fixed in place over the image sensor. Because the lens structure 26 faces the aperture 18, the lens structure can more easily be protected from scratches or other damage that might otherwise occur during assembly.

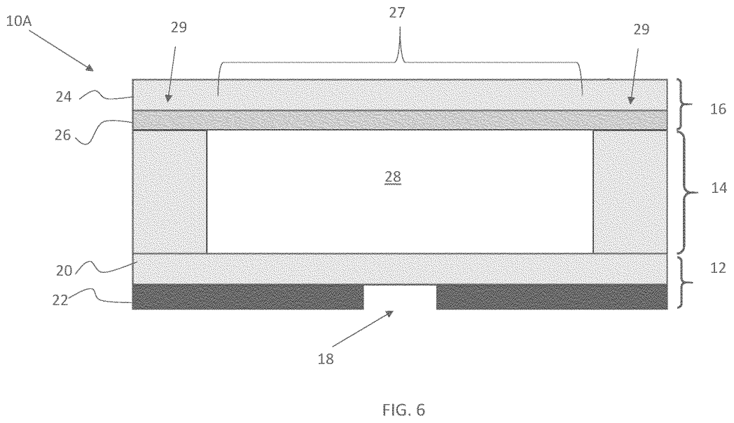

Although the foregoing implementations show the aperture 18 and the metal layer (e.g., black chrome coating) 22 facing the lens structure 26, in some implementations the metal layer (e.g., black chrome coating) 22 may be on the exterior of the first support 20 such that the metal layer 22 faces away from the lens structure, as shown in the example optical device 10A of FIG. 6. Nevertheless, in both this and the other examples described above, the lens structure 26 faces the aperture substrate 12, which includes a first support on which a metal layer that defines the optical aperture is disposed. The optical device 10A also can be integrated into an optoelectronic assembly, such as a light sensing module.

The implementations of FIGS. 5 and 6 can present a trade-off in some cases. For example, changing the index of refraction between the aperture stop and nanostructure may influence the optical performance. Thus, in the implementation of FIG. 6, the support (i.e., the cover glass) 20 is located after the aperture stop, and the index of refraction changes between the aperture stop and the nanostructure. As a result, optical performance may be reduced slightly due to optical aberrations. On the other hand, in the implementation of FIG. 5, where the cover glass is located before the aperture stop, the presence of the coverglass will not affect optical performance. Nevertheless, a potential benefit of using the implementation of FIG. 6 is that, compared with the implementation of FIG. 5, the device can be more compact. For example, if the cover glass 20 in FIG. 6 is sufficiently thin (e.g., on the order of about 200 μm or possibly even less in some cases), little optical performance will be lost, and a highly compact device still can be achieved. Further, in such a design, the nano-structure can still be protected from both sides.

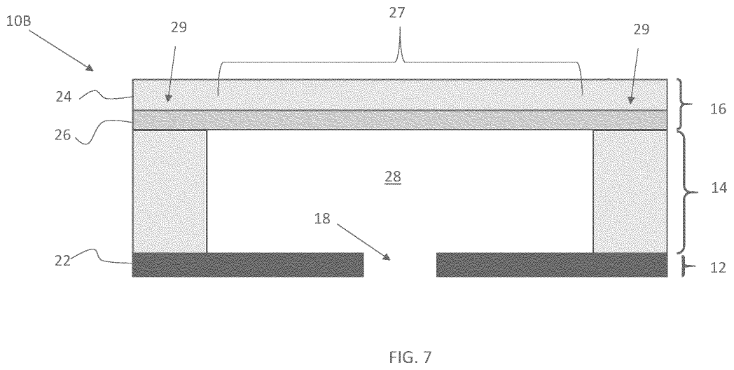

In some implementations, as illustrated in the example optical device 10B of FIG. 7, the coverglass 20 can be omitted. That is, the aperture substrate 12 defines an aperture 18, but there is no coverglass 20. With no coverglass at the aperture stop, a highly compact design can be achieved. Further, as the lens structure 26 still faces the aperture substrate 12, the meta-atoms (e.g., nanostructures) of the lens structure 26 can be substantially protected within the housing.

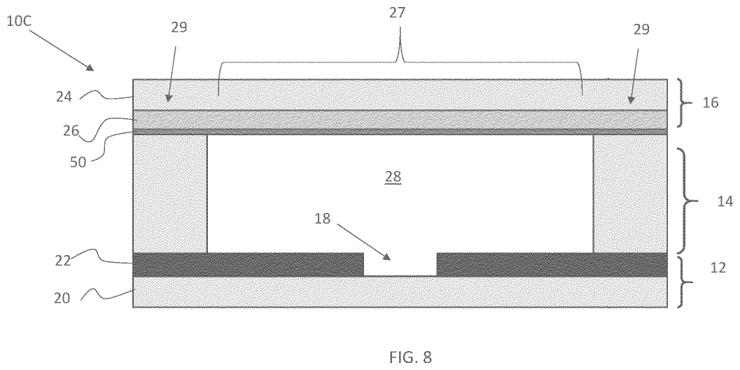

In some implementation, as shown in the example of FIG. 8, the lens structure 26 (i.e., the metasurface) of the device 10C is covered by a protective covering 50 disposed on the side of the metasurface opposite that of the support 24. This arrangement can provide even more protection for the metasurface. In some implementations, the protective covering 50 is an encapsulation layer composed, for example, of a material that is optically clear at the application wavelength. For example, in some instances, the encapsulation layer 50 is composed of a polymer. The encapsulation layer 50 can be relatively thin (e.g., 1-3 μm in some instances) so as to reduce the extent of any adverse impact on optical performance. In some implementations, the protective covering 50 is a relatively thin cover glass. For example, the protective covering 50 can be implemented as a SCHOTT MEMpax® ultra-thin borosilicate glass having a thickness, e.g., of 70 μm. Other materials and/or thicknesses may be used for the protective covering 50 in some implementations.

In some instances, one or more light sensing modules, as described above, can be integrated, for example, into mobile phones, laptops, televisions, wearable devices, or automotive vehicles.

While this specification contains many specifics, these should not be construed as limitations on the scope of the disclosure or of what may be claimed, but rather as descriptions of features specific to particular implementations. Certain features that are described in this specification in the context of separate implementations may also be combined in the same implementation. Conversely, various features that are described in the context of a single implementation may also be implemented in multiple implementations separately or in any suitable sub-combination. Various modifications can be made to the foregoing examples. Accordingly, other implementations also are within the scope of the claims.

1. An apparatus comprising:
an aperture substrate having an optical aperture;
a lens substrate including a lens structure on a support, the lens structure being closer to the aperture substrate than is the support, and the lens structure being defined throughout a metasurface distributed across a surface of the support and comprising meta-atoms configured to change a local amplitude, a local phase, or both, of a light wave at an application wavelength, and the support being transparent to the application wavelength; and
a spacer, wherein a first end of the spacer is attached to the aperture substrate, and a second end of the spacer is attached either to the lens substrate or to a protective covering that covers the metasurface, and
wherein an opening extends through the spacer from the first end to the second end, wherein the opening has an index of refraction equal to or less than 1.0.

2. The apparatus of claim 1 wherein the aperture substrate includes a first support on which a metal layer is disposed, the metal layer defining the optical aperture, and the first support being transparent to the application wavelength.

3. The apparatus of claim 2 wherein the lens structure faces the optical aperture.

4. The apparatus of claim 2 wherein the lens structure faces the first support.

5. The apparatus of claim 2, wherein the support on which the lens structure is disposed and the first support on which the metal layer is disposed are composed of glass.

6. The apparatus of claim 2, wherein the metal layer defining the optical aperture is composed of a black chrome coating.

7. The apparatus of claim 1, wherein the opening contains air.

8. The apparatus of claim 1 wherein the lens structure includes an optically active region surrounded laterally by an optically inactive region, and wherein the second end of the spacer is attached to the optically inactive region of the lens structure.

9. The apparatus of claim 1, further comprising:
an image sensor disposed so that light entering through the optical aperture passes through the lens structure and then is incident on the image sensor.

10. A method comprising:
providing a first wafer on which a metal layer is disposed, the metal layer defining optical apertures, and the first wafer being transparent to an application wavelength;
providing a second wafer having a lens structure on a surface of the second wafer, wherein the lens structure is defined by a metastructure distributed across a surface of the second wafer and comprising meta-atoms configured to change a local amplitude, a local phase, or both, of a light wave at the application wavelength, the second wafer being transparent to the application wavelength;
providing a spacer wafer, wherein there are openings extending through the spacer wafer from a first side of the spacer wafer to a second side of the spacer, wherein the openings have an index of refraction equal to or less than 1.0; and
attaching the first side of the spacer wafer to the first wafer and attaching the second side of the spacer wafer either to the second wafer, or to a protective covering that covers the metastructure, to form a wafer stack, wherein the lens structure is closer to the first wafer than is the second wafer, and wherein each of the optical apertures is aligned with a respective one of the openings in the spacer wafer.

11. The method of claim 10 further including:
separating the wafer stack into individual optical devices.

12. The method of claim 11 further comprising:
providing an image sensor so that light entering through the optical aperture of one of the individual optical devices passes through the lens structure and then is incident on the image sensor.

13. The method of claim 10, wherein the first wafer and the second wafer are composed of glass.

14. The method of claim 13 wherein the spacer wafer is composed of glass.

15. The method of claim 10, wherein the metal layer defining the optical apertures is composed of a black chrome coating.

16. The method of claim 10, wherein the openings contain air.

17. The method of claim 10 wherein the lens structure includes optically active regions each of which is surrounded laterally by a respective optically inactive region, and wherein the method includes attaching the optically inactive regions to the second side of the spacer wafer.
